(19) United States
(12) Patent Application Publication
(10) Pub. No.: US 2007/0098075 A1
(43) Pub. Date: May 3, 2007

(54) Motion vector estimating device and motion vector estimating method

(76) Inventors: Hideyuki Ohgose, Osaka (JP); Tatsuro Juri, Osaka (JP); Hiroshi Arakawa, Nara (JP); Katsuo Saigo, Hyogo (JP); Koji Arimura, Osaka (JP); Yuuki Maruyama, Osaka (JP); Kei Tasaka, Nara (JP)

Correspondence Address: MCDERMOTT WILL & EMERY LLP, 600 13TH STREET, N.W., WASHINGTON, DC, 20005-3096, US

(21) Appl. No.: 11/586,584

(22) Filed: Oct. 26, 2006

(30) Foreign Application Priority Data
Oct. 28, 2005 (JP) 2005-315461

(51) Int. Cl. H04N 11/02; H04N 11/04

(52) U.S. Cl. 375/240.16; 375/240.24

(57) ABSTRACT

To provide a motion vector estimating device and a motion vector estimating method which are capable of estimating motion vectors with a high accuracy while reducing the processing amount. The picture coding apparatus includes: a picture reducing unit which generates a reduced picture to be coded and a reduced reference picture based on an input picture including a current block and a reference picture, an area dividing unit which divides the reduced picture to be coded into plural areas, an area motion vector estimating unit which estimates, for each area, an area motion vector with respect to the reduced reference picture, a correlation calculating unit which calculates the correlation of each area motion vector, a correlation calculating unit which calculates, for each area, the correlation of the area motion vector, a search range determining unit which determines the information about the motion vector search range based on the area motion vectors and the correlations of the area motion vectors, and a coding unit which has a motion estimating unit. The motion estimating unit determines motion vector search ranges and estimates motion vectors.

### BACKGROUND OF THE INVENTION

(1) Field of the Invention

The present invention relates to a motion vector estimating device and a method thereof used in a picture coding apparatus which codes a moving picture by performing inter-picture prediction.

(2) Description of the Related Art

In a picture compressing method that uses a correlation between the pictures of a moving picture such as Moving Picture image coding Exparts Group (MPEG) method, motion vectors must be estimated for each block based on which motion compensation is performed. In order to estimate motion vectors with a high accuracy, a method of improving the accuracy when estimating motion vectors by enlarging a search range is generally used. However, since the processing amount is determined depending on the number of blocks to be processed and the search range, enlarging the search range increases the processing amount. This results in an increase in memory amount. Thus, there is a need to estimate motion vectors with a high accuracy without enlarging the search range.

As such a method of estimating motion vectors with a high accuracy without enlarging the search range like this, there has been provided a moving picture coding apparatus which determines a search range based on the size of the motion vector estimated in the past of a macroblock and the type of the macroblock (for example, refer to Japanese Laid-open Patent Application No. 11-112993).

However, in the case of determining the search range based on the sizes of the motion vectors estimated in the past and the type of macroblock in this way, there is a need to store the motion vectors estimated in the past. This causes a problem that the memory amount increases.

The number of pixels in a High-Definition (HD) picture which is coming into greater use is about six times greater than the number of pixels in a Standard Definition (SD) picture. Therefore, in order to realize an equivalent accuracy in estimating motion vectors in such HD picture to the accuracy in estimating motion vectors in an SD picture, about six times processing amount is required. In addition, in the H.264 standard, the motion compensation sizes include as many as seven types, and thus the required processing amount is about three times that of the MPEG-2 standard. Accordingly, in order to compress the HD picture by using the H.264 standard, the required processing amount is about 18 times that required when compressing an SD picture by using the MPEG-2 standard.

For this reason, the present invention has been considered in view of the circumstances. The present invention has an object to provide a motion vector estimating device and a motion vector estimating method which are capable of estimating motion vectors with a high accuracy while reducing the processing amount.

### SUMMARY OF THE INVENTION

In order to achieve the object, the motion vector estimating device of the present invention estimates a motion vector of a current block included in a picture to be coded with respect to a reference picture. The device includes: a picture reducing unit which generates, based on the picture to be coded and the reference picture, a reduced picture to be coded and a reduced reference picture each having a reduced number of pixels; an area dividing unit which divides the reduced picture to be coded into a plurality of areas; an area motion vector estimating unit which estimates an area motion vector which is a motion vector of each area obtained by the division performed by the area dividing unit, with respect to the reduced reference picture; a search range determining unit which determines, based on the area motion vector, information about a motion vector search range of the current block included in the divided area; and a motion estimating unit which estimates a motion vector of the current block by determining the motion vector search range of the current block based on the information about the motion vector search range determined by the search range determining unit and by searching the determined motion vector search range. In this way, the information about the motion vector search range is determined based on the area motion vector. The information includes: the size of the motion vector search range of the current block, the shift amount of the motion vector search range, the amount of search position decimation in searching motion vectors, and the amount of pixel decimation in calculating evaluation values of the blocks. Thus, it is possible to determine a motion vector search range efficiently. This makes it possible to estimate a motion vector of a current block with a high accuracy.

Here, in the motion vector estimating device, the search range determining unit determines, based on the area motion vector, a shift amount determined as the information about the motion vector search range with respect to the standard position of the motion vector search range, and the motion estimating unit determines the motion vector search range that is shifted from the standard position by the shift amount determined by the search range determining unit. In this way, the shift amount of the motion vector search range of the current block is determined based on the area motion vector. Thus, it is possible to determine a motion vector search range efficiently. This makes it possible to estimate a motion vector of a current block with a high accuracy.

In addition, the motion vector estimating device further includes a correlation calculating unit which calculates a correlation between the divided area picture and a divided area predictive picture which is generated based on the area motion vector and the reduced reference picture. In the device, the search range determining unit determines information about the motion vector search range based on the area motion vector and the correlation. In this way, the information about the motion vector search range is determined based on the area motion vector and the correlation of the area motion vector. The information includes: the size of the motion vector search range of the current block, the shift amount of the motion vector search range, the amount of search position decimation in searching motion vectors, and the amount of pixel decimation in calculating evaluation values of the blocks. Thus, it is possible to determine a motion vector search range more efficiently. This makes it possible to estimate a motion vector of a current block with a higher accuracy.

In addition, in the motion vector estimating device, the search range determining unit determines, based on the area motion vector and the correlation, the shift amount determined as the information about the motion vector search range with respect to the standard position of the motion vector search range, and the motion estimating unit determines the motion vector search range that is shifted from the standard position by the shift amount determined by the search range determining unit. In this way, the shift amount of the motion vector search range of the current block is determined based on the area motion vector and the correlation of the area motion vector. Thus, it is possible to determine a motion vector search range more efficiently. This makes it possible to estimate a motion vector of a current block with a higher accuracy.

In addition, in the motion vector estimating device, the search range determining unit determines the size of the motion vector search range based on the correlation as the information about the motion vector search range, and the motion estimating unit determines the motion vector search range having the size of the motion vector search range determined by the search range determining unit. In this way, the size of the motion vector search range of the current block is determined based on the correlation of the area motion vector. Thus, it is possible to determine a motion vector search range more efficiently. This makes it possible to estimate a motion vector of a current block with a higher accuracy.

In addition, in the motion vector estimating device, the search range determining unit determines the size, which is determined as the information about the motion vector search range, of the motion vector search range based on the area motion vector and the correlation, and the motion vector estimating unit determines the motion vector search range having the size of the motion vector search range determined by the search range determining unit. In this way, the size of the motion vector search range of the current block is determined based on the area motion vector and the correlation of the area motion vector. Thus, it is possible to determine a motion vector search range more efficiently. This makes it possible to estimate a motion vector of a current block with a higher accuracy.

In addition, in the motion vector estimating device, the search range determining unit corrects the information about the motion vector search range with respect to a block which is positioned around the boundary between the divided areas, according to the correlations of the respective divided areas adjacent to each other. This makes it possible to efficiently determine a motion vector search range as to a block which is present around a boundary between the divided areas and estimate a motion vector with a high accuracy.

In addition, in the motion vector estimating device, the search range determining unit determines, based on the area motion vector, the shift amount determined as the information about the motion vector search range with respect to the standard position of the motion vector search range, and the motion estimating unit determines, as the motion vector search range, a motion vector search range of the standard position and a range shifted from the standard position by the shift amount determined by the search range determining unit. With this, even in the case of setting each search range to be narrow for example, it is possible to estimate a motion vector with a high accuracy by searching plural search ranges which provide a high probability of estimating a highly accurate motion vector.

Note that the present invention can be realized as not only a motion vector estimating device like this, but also as a motion vector estimating method having the steps corresponding to the unique steps provided with the motion vector estimating device like this and as a program causing a computer to execute these steps. Additionally, the program can be distributed via a recording medium such as a CD-ROM and a communication medium such as the Internet.

### FURTHER INFORMATION ABOUT TECHNICAL BACKGROUND TO THIS APPLICATION

The disclosure of Japanese Patent Application No. 2005-315461 filed on Oct. 28, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing the structure of the moving picture coding apparatus which has a motion vector estimating device according to a first embodiment of the present invention;

FIG. 2 is a block diagram showing the structure of a coding unit of the moving picture coding apparatus;

FIG. 3 is a flow chart indicating an operation flow in the case of determining information about motion vector search ranges;

FIG. 4A is a diagram showing how a reduced picture to be coded is divided; FIG. 4B is a diagram showing a matching between the area B and a reduced reference picture; FIG. 4C is a diagram indicating the equation for calculating a correlation;

FIG. 5 is a diagram for illustrating how to shift the motion vector search ranges;

FIG. 6 is a diagram for illustrating the sizes and how to shift the motion vector search ranges;

FIG. 7 is a diagram for illustrating the amount of decimation of motion vector search positions;

FIG. 8 is a diagram for illustrating the amount of pixel decimation in calculating evaluation values of blocks at the time of motion vector search;

FIG. 9 is a diagram for illustrating a method of setting search ranges in the motion vector estimating device according to a second embodiment of the present invention;

FIG. 10 is a diagram for illustrating another method of setting search ranges in a motion vector estimating device according to a second embodiment of the present invention; and

FIG. 11 is a diagram for illustrating a method of correcting information about motion vector search ranges in a motion vector estimating device according to a third embodiment of the present invention.

### DESCRIPTION OF THE PREFERRED EMBODIMENT(S)

Embodiments of the present invention will be described below with reference to the drawings.

### First Embodiment

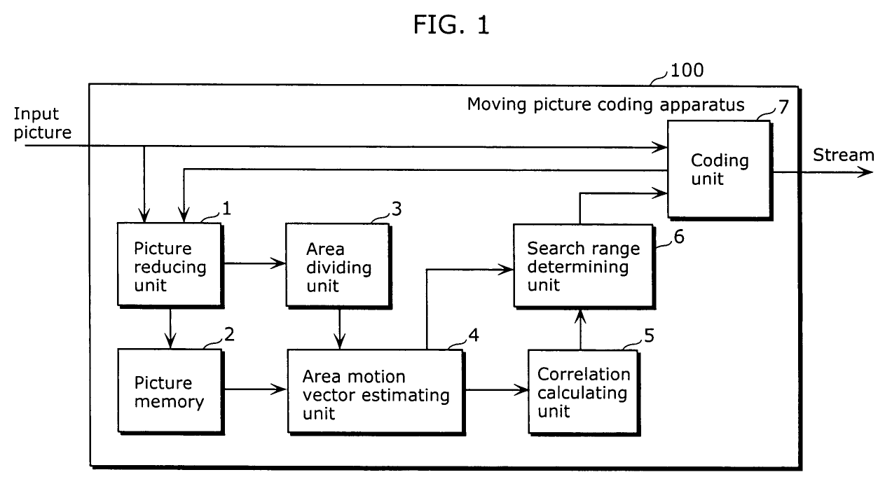

FIG. 1 is a block diagram showing the structure of a moving picture coding apparatus which has a motion vector estimating device according to a first embodiment of the present invention.

The moving picture coding apparatus 100 is intended for coding an inputted moving picture to be inputted on a per block basis. As shown in FIG. 1, it includes: a picture reducing unit 1, a picture memory 2, an area dividing unit 3, an area motion vector estimating unit 4, a correlation calculating unit 5, a search range determining unit 6, and a coding unit 7. It is assumed in this embodiment that the coding unit 7 performs coding according to the MPEG-2 standard. In addition, it is assumed that a single rectangular area is searched in the motion vector estimation which is actually performed by the coding unit 7 on a per macroblock basis.

The picture reducing unit 1 receives a picture to be coded (input picture) including a macroblock (current block) which should be coded and a reference picture which is referred to so that a motion vector for coding the current block is estimated. It generates a reduced picture to be coded and a reduced reference picture each having pixels reduced by calculating peripheral pixels. In the picture memory 2, the reduced reference picture generated by the picture reducing unit 1 is stored.

The area dividing unit 3 divides the reduced picture to be coded which has been generated by the picture reducing unit 1 into plural areas (divided areas). The area motion vector estimating unit 4 estimates area motion vectors with respect to the reduced reference picture generated by the picture reducing unit 1 for each area obtained by the division performed by the area dividing unit 3. In other words, the area motion vector estimating unit 4 calculates the position of the picture area, which is included in the reduced reference picture, nearest to each area, and estimates the motion vector indicating this position as the area motion vector.

The correlation calculating unit 5 calculates, for each area, the correlation which is an index indicating a likelihood of the area motion vector estimated by the area motion vector estimating unit 4. In other words, the correlation calculating unit 5 calculates the correlation of the area motion vector of each area by using the covariance of the picture value included in the reduced reference picture shown by the area and the area motion vector.

The search range determining unit 6 determines information about the motion vector search range based on the area motion vector estimated by the area motion vector estimating unit 4 and the correlation of the area motion vector calculated by the correlation calculating unit 5. The information includes: the size of the motion vector search range, the shift amount of the motion vector search range, the amount of search position decimation at the time of motion vector search, and the amount of pixel decimation in calculating evaluated values of the blocks.

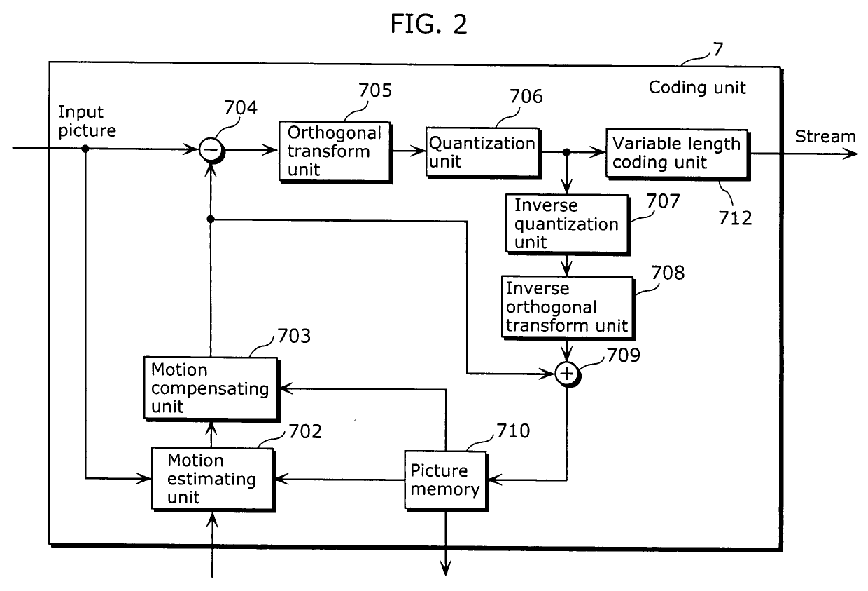

FIG. 2 is a block diagram showing the structure of the coding unit 7 of the moving picture coding apparatus 100.

The coding unit 7 includes: a motion estimating unit 702, a motion compensating unit 703, a difference calculating unit 704, an orthogonal transform unit 705, a quantization unit 706, an inverse quantization unit 707, an inverse orthogonal transform unit 708, an adding unit 709, a picture memory 710, and a variable length coding unit 712.

The input picture is inputted to the motion estimating unit 702 and the difference calculating unit 704.

The motion estimating unit 702 determines the motion vector search range of the current block by using the information about the motion vector search range determined by the search range determining unit 6, and searches a reference picture stored in the picture memory 710 within the determined motion vector search range. By doing so, it estimates the picture area closest to the current block and estimates the motion vector indicating the position of the picture area. Here, the picture area closest to the current block provides the minimum sum of absolute difference obtained by calculating, for example, the sum of absolute difference between the data of the pixels which are present in the search area included in the reference picture and the data of the pixels in the current block.

The motion compensating unit 703 extracts the picture area which is optimum as a predictive picture from among the decoded pictures stored in the picture memory 710 by using the motion vector estimated by the motion estimating unit 702, and generates a predictive picture.

On the other hand, the difference calculating unit 704 which has received the input picture calculates a difference value between the input picture and the predictive picture, and outputs the difference value to the orthogonal transform unit 705. The orthogonal transform unit 705 transforms the difference value into a frequency coefficient, and outputs the frequency coefficient to the quantization unit 706. The quantization unit 706 quantizes the inputted frequency coefficient, and outputs the quantized value to the variable length coding unit 712.

The inverse quantization unit 707 reverts the inputted quantized value by performing inverse quantization of the quantized value, and outputs the reverted value to the inverse orthogonal transform unit 708. The inverse orthogonal transform unit 708 performs inverse frequency transform from the frequency coefficient to the pixel difference value, and outputs the pixel difference value to the adding unit 709. The adding unit 709 calculates decoded picture by adding the pixel difference value and the predictive picture to be outputted from the motion compensating unit 703. The variable length coding unit 111 performs variable length coding of the quantized value and motion vector and the like so as to output a stream.

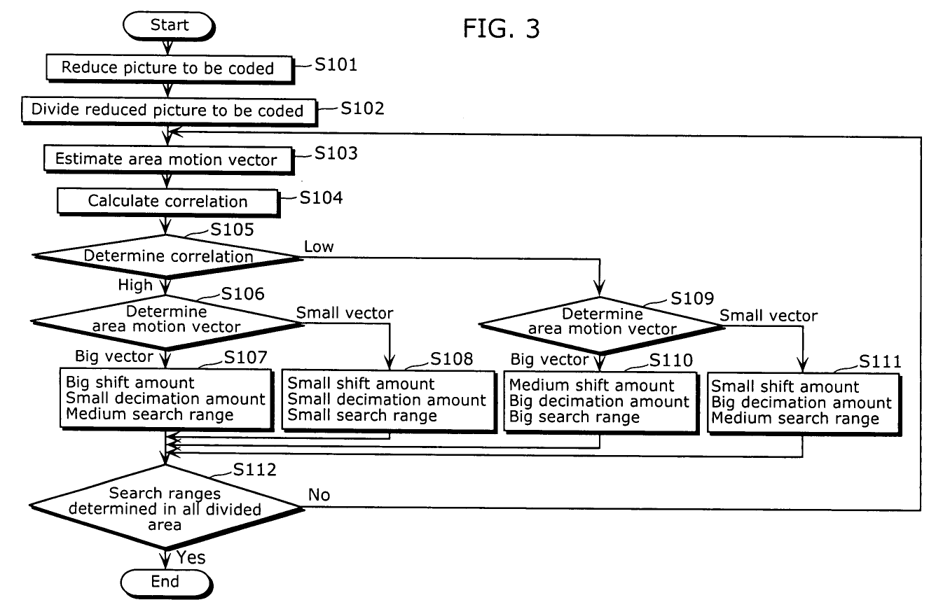

Next, a description is made as to the operation of the moving picture coding apparatus 100 having the motion vector estimating device structured like this. FIG. 3 is a flow chart indicating the operation flow at the time of determining the information about the motion vector search range.

First, the picture reducing unit 1 receives a picture to be coded. The picture to be coded is made up of, for example, 1920 pixels×1080 pixels, and includes a current block which should be coded. It is assumed in this embodiment that coding is performed according to the MPEG-2 standard. Thus, the current block is a macroblock made up of 16 pixels×16 pixels. The picture reducing unit 1 reduces the pixels included in the picture to be coded and generates a reduced picture to be coded (Step S101).

In addition, the picture reducing unit 1 receives a reference picture which has been locally decoded by the coding unit. The locally-decoded reference picture is made up of, for example, 1920 pixels×1080 pixels similarly to the picture to be coded. The picture reducing unit 1 reduces the pixels included in the reference picture and generates the reduced reference picture. Subsequently, the reduced reference picture generated by the picture reducing unit 1 is stored in the picture memory 2.

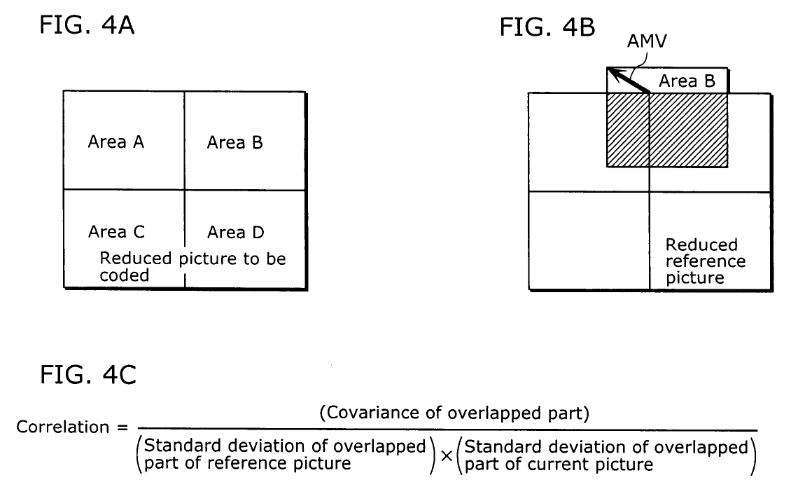

Next, the area dividing unit 3 divides the reduced picture to be coded which has been generated by the picture reducing unit 1 into plural areas (Step S102). Here, as shown in FIG. 4A, the reduced picture to be coded is divided into two both horizontally and vertically so as to divide into four areas of areas A, B, C and D.

Next, the area motion vector estimating unit 4 estimates an area motion vector with respect to the reduced reference picture generated by the picture reducing unit 1 for each area obtained by the division performed by the area dividing unit 3 (Step S103). For example, as shown in FIG. 4B, when the area motion vector AMV of the area B is estimated, the evaluation value is calculated by performing matching by using only the part overlapped with the reduced reference picture. At this time, since the evaluation value becomes small as the overlapped part gets narrower, a value corrected by using the size of the overlapped part is calculated. Subsequently, the area motion vector estimating unit 4 calculates the position which enables to provide the minimum corrected evaluation value and estimate the motion vector indicating this position as the area motion vector AMV. Note that such matching is not performed by only using the part overlapped with the reduced reference picture. Such matching may be performed by using the whole area, for example, after compensating the pixel data of an area outside the reduced reference picture.

Next, the correlation calculating unit 5 calculates, for each area, a correlation which is an index indicating the likelihood of the area motion vector AMV estimated by the area motion vector estimating unit 4 (Step S104). In other words, the correlation calculating unit 5 calculates the correlation of the overlapped part corresponding to the likelihood of the area motion vector AMV as shown in FIG. 4B by calculating the covariance of the overlapped part and calculating it by using the formula shown as FIG. 4C. Here, the covariance of the overlapped part is calculated. However, it should be noted that other indices such as sum of absolute difference of the pixels in the overlapped part may be used.

Next, the search range determining unit 6 determines whether or not the correlation of the area motion vector AMV calculated by the correlation calculating unit 5 is greater than a predetermined threshold value (Step S105). In the case where the result shows that the correlation of the area motion vector AMV is greater than the predetermined threshold value (Yes in Step S105), the search range determining unit 6 determines whether or not the area motion vector AMV estimated by the area motion vector estimating unit 4 is greater than the predetermined threshold value (Step S106). In the case where the result shows that the area motion vector AMV is greater than the predetermined threshold value (Yes in Step S106), the search range determining unit 6 determines an area motion vector which realizes a big shift amount of the motion vector search range, a small amount of search position decimation in the motion vector search range and a medium search range (Step S107). On the other hand, in the case where the result shows that the area motion vector AMV is not greater than the predetermined threshold value (No in Step S105), the search range determining unit 6 determines an area motion vector which realizes a small shift amount of the motion vector search range, a small amount of search position decimation in the motion vector search range and a small search range (Step S108).

In addition, in the case where the correlation of the area motion vector is not greater than the predetermined threshold value (No in Step S105), the search range determining unit 6 determines whether or not the area motion vector AMV estimated by the area motion vector estimating unit 4 is greater than the threshold value (Step S109). In the case where the result shows that the area motion vector AMV is greater than the threshold value (Yes in Step S109), the search range determining unit 6 determines an area motion vector which realizes a medium shift amount of the motion vector search range, a big amount of search position decimation in the motion vector search range and a big search range (Step 5110). In the other case where the result shows that the area motion vector AMV is not greater than the threshold value (No in Step S109), the search range determining unit 6 determines an area motion vector which realizes a small shift amount of the motion vector search range, a big amount of search position decimation in the motion vector search range and a medium search range (Step S111).

When the correlation is high, it can be judged that the matching degree between the pictures is high, and that the accuracy of the area motion vector AMV is high. When the accuracy of the area motion vector AMV is high, it can be judged that the motion vectors in the current block do not vary so much. Therefore, as shown above, when the correlation is high, a search area is determined to be smaller compared with the one in the case where the correlation is low. In addition, in this case, the amount of search position decimation is determined to be small. On the other hand, when the correlation is low, it can be judged that the matching degree between the pictures is low, and that the accuracy of the area motion vector AMV is low. When the accuracy of the area motion vector AMV is low, it can be judged that the motion vectors in the current block vary greatly. Therefore, as shown above, when the correlation is low, a search area is determined to be bigger compared with the one in the case where the correlation is high. In addition, since the processing amount increases when the search area is determined to be bigger, the amount of search position decimation is determined to be big.

As for the size and the correlation of the area motion vector in this embodiment, the conditions are divided into two respectively based on whether or not the respective predetermined threshold values are greater than the predetermined threshold value, and thus there are four cases in total where the information about the motion vector search areas are determined. However, such cases are not limited to these. For example, plural threshold values may be prepared, the conditions may be divided into three, and the cases may be further divided.

Next, a description is made as to determination of motion vector search range and motion vector search that the motion estimating unit 702 of the determination coding unit 7 performs by using the information about the motion vector search range determined as described above.

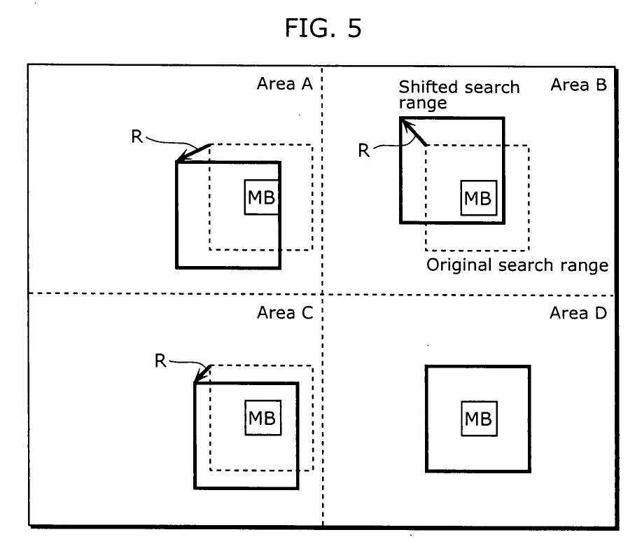

First, how to shift the search range is described. FIG. 5 is a diagram for illustrating how to shift the motion vector search range.

Similarly to the case of a reduced picture to be coded, a picture to be coded is divided into two both horizontally and vertically so as to be divided into four areas. The respective areas correspond to the areas A to D of the reduced picture to be coded. The search range of the standard position is enclosed by the dotted lines shown in FIG. 5, and the enclosed search range has a current block as the center. The motion estimating unit 702 shifts the search range from the standard position by the shift amount R of the search range in each area determined by the search range determination unit 6 so as to search a motion vector within the range enclosed by the solid lines shown in FIG. 5. In the case where there is the shift amount R for example like the areas A, B and C as shown in FIG. 5, the search ranges are shifted by the shift amount R respectively. In the case where the shift amount R is 0 like the area D, the search range is the same as the search range of the standard position.

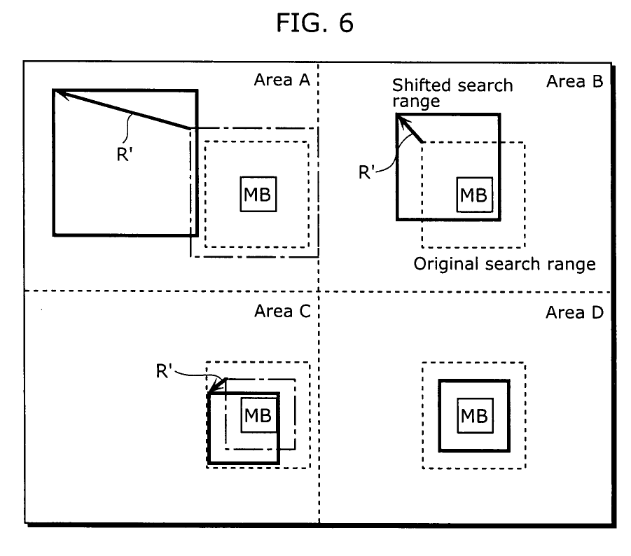

Next, the size of the motion vector search range is described. FIG. 6 is a diagram for illustrating the size of the motion vector search range and how to shift the search range.

Similarly to the above, the search range of the standard position is enclosed by the dotted lines shown in FIG. 6, and the range has the current block as the center. The motion estimating unit 702 enlarges the search range of the standard position by a predetermined amount, keeps the search range unchanged, or reduces it by a predetermined amount according to the size of the motion vector search range in each area determined by the search range determining unit 6. It shifts the search range by the shift amount R′, and searches a motion vector within the area enclosed by the solid lines shown in FIG. 6. For example, in the case where the search range is big and there is the shift amount R′, the search range of the standard position is enlarged by a predetermined range like the area A shown in FIG. 6, and shifts the enlarged search range by the shift amount R′. In addition, in the case where the search range is medium and there is the shift amount R′, it keeps the search range of the standard position unchanged like the area B shown in FIG. 6, and shifts the search range by the shift amount R′. In the case where the search amount is small and there is the shift amount R′, the search range of the standard position is shifted by the shift amount R′. In the case where the search range is small and there is the shift amount R′, the search range of the standard position is reduced by a predetermined amount like the area C shown in FIG. 6 and shifts the reduced search range by the shift amount R′. In addition, in the case where the search range is small and the shift amount R′ is 0, the search range of the standard position is the reduced search range like the area D shown in FIG. 6. It is assumed here that the search range of the standard position is enlarged or reduced. However, it should be noted that the search range is not always enlarged or reduced. The size of the search range may be changed into a predetermined size, and the search range may be shifted by the shift amount.

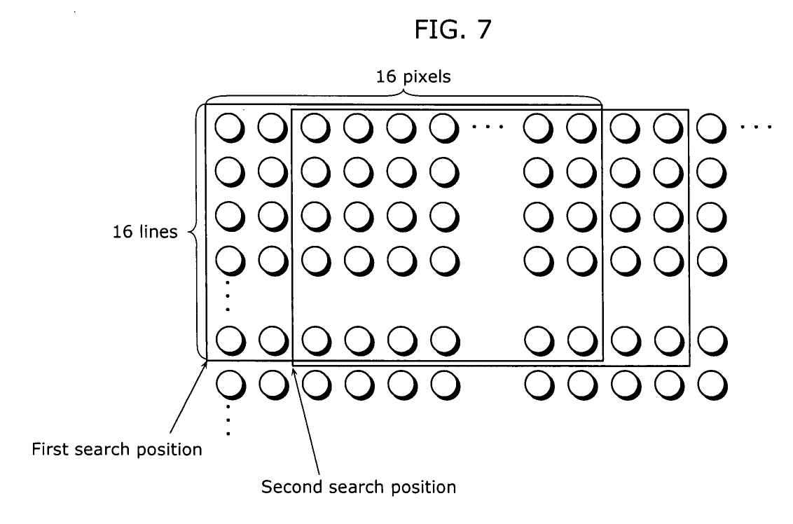

Next, the amount of search position decimation is described. FIG. 7 is a diagram for illustrating the amount of decimation of motion vector search positions.

In the case where the search range is enlarged by the search range determining unit 6, when evaluation values are respectively calculated at all the positions and a motion vector is searched, the processing amount increases in proportion to the size of the search range. As a method of enlarging the search range without increasing the processing amount, search position decimation is performed. For example, in the case of performing such search position decimation to a half horizontally, the motion estimating unit 702 performs a search for each position horizontally shifted by the every other pixel as shown in FIG. 7 in the following order of the first search position, the second search position, the third search position and so on.

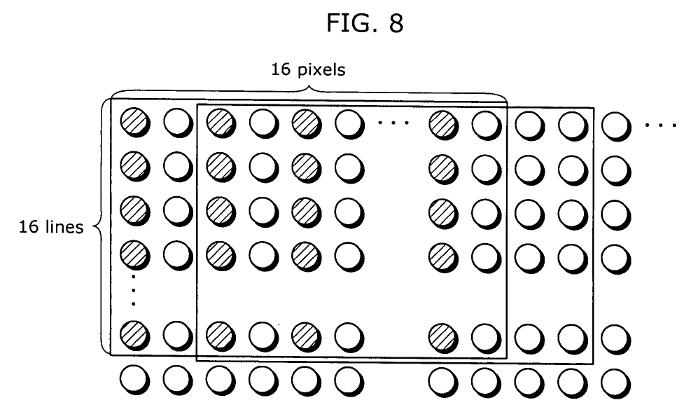

Next, the amount of pixel decimation in calculating the evaluation values is described. FIG. 8 is a diagram for illustrating the amount of pixel decimation in calculating the evaluation values at the time of searching motion vectors.

The purpose of using the amount of pixel decimation in calculating the evaluation values at the time of searching motion vectors is the same as the purpose of the amount of search position decimation. The use of the amount of search position decimation is a method of enlarging the search area while keeping the processing amount. For example, in the case of performing search position decimation to a half horizontally, the motion estimating unit 702 calculates evaluation values by using the data of pixels positioned horizontally at every other pixel position as shown in FIG. 8. It is general that the sum of absolute difference between all pixels in the current block and all pixels in the search position is calculated. However, here, the sum of absolute difference between the shaded pixels in FIG. 8 and the corresponding pixels is calculated.

As described above, in this embodiment, the information about the motion vector search range such as the size of the motion vector search range, the shift amount of the motion vector search range, the amount of search position decimation at the time of searching motion vectors and the amount of pixel decimation in calculating the evaluation values of the blocks are determined based on the correlation between the area motion vectors estimated by the area motion vector estimating unit 4 and the area motion vectors estimated by the correlation calculating unit 5. Accordingly, it is possible to determine the motion vector search range efficiently and estimate a motion vector with a high accuracy.

### Second Embodiment

In the first embodiment, a description is made as to the case where the motion vector search area at the time of estimating motion vectors in the motion estimating unit 702 is 1. In this embodiment, a description is made as to the case where plural motion vector search areas are prepared.

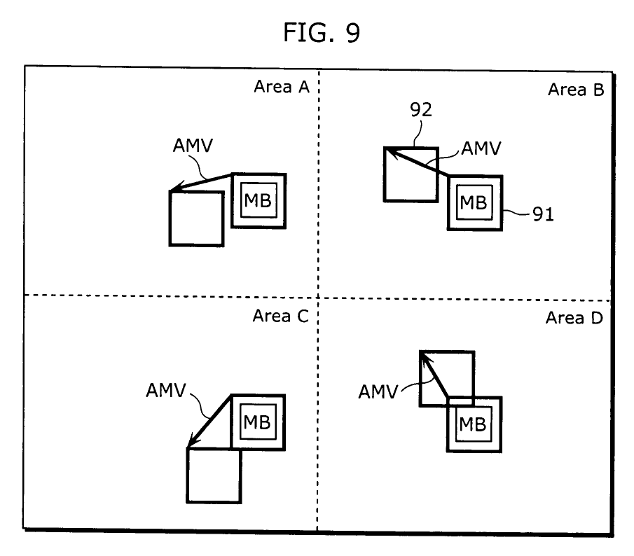

FIG. 9 is a diagram for illustrating how to set the search area in the motion vector estimating device according to the second embodiment. Since the motion vector estimating device is the same in structure as the motion vector estimating device in the first embodiment, a description of it is omitted.

As shown in FIG. 9, the motion estimating unit 702 searches the search areas 91 and 92. The search area 91 is in a rectangular area which has a predetermined size and has, as the center, the block (macroblock) to be coded. The search area 92 is in a rectangular area which has the position indicating, as the center, the area motion vector AMV. Similarly to the first embodiment, this search area 92 may be changed in the respect of the amount of search position decimation, the amount of pixel decimation in calculating an evaluation value and the size of the search range based on the correlation and the size of an area motion vector.

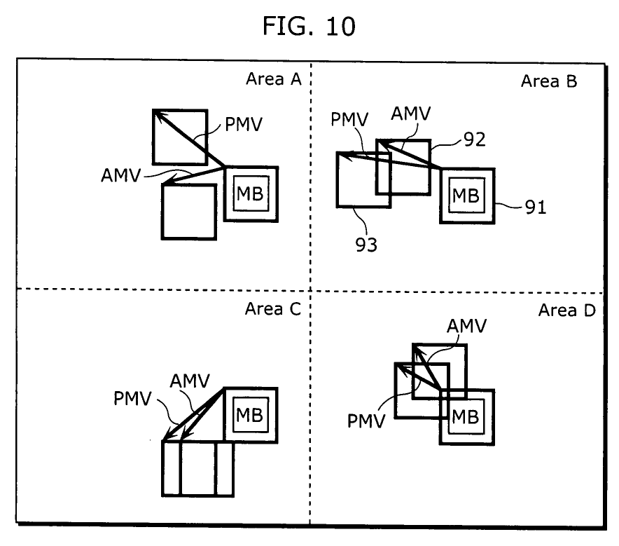

It is assumed here that two search ranges are searched, but note that it is possible to search a rectangular area which has, as the center, the position indicating a predictive vector determined in the MPEG-2 standard. In this case, as shown in FIG. 10, the motion estimating unit 702 searches a search range 93 of a rectangular area which has, as the center, the position indicated by the predictive vector PMV in addition to the search range 91 of a rectangular area which has the predetermined size and has, as the center, the block (macroblock) to be coded and the search range 92 of a rectangular area which has, as the center, the position indicated by the predictive vector PMV.

As described above, searching the search range 91 which has the current block as the center and the search range 92 based on the area motion vector AMV makes it possible to estimate a motion vector with a high accuracy even if each search range is set to be small.

### Third Embodiment

In this embodiment, a description is made as to the case where the information about the motion vector search range with respect to the macroblock (current block) which is present in contact with a boundary between areas.

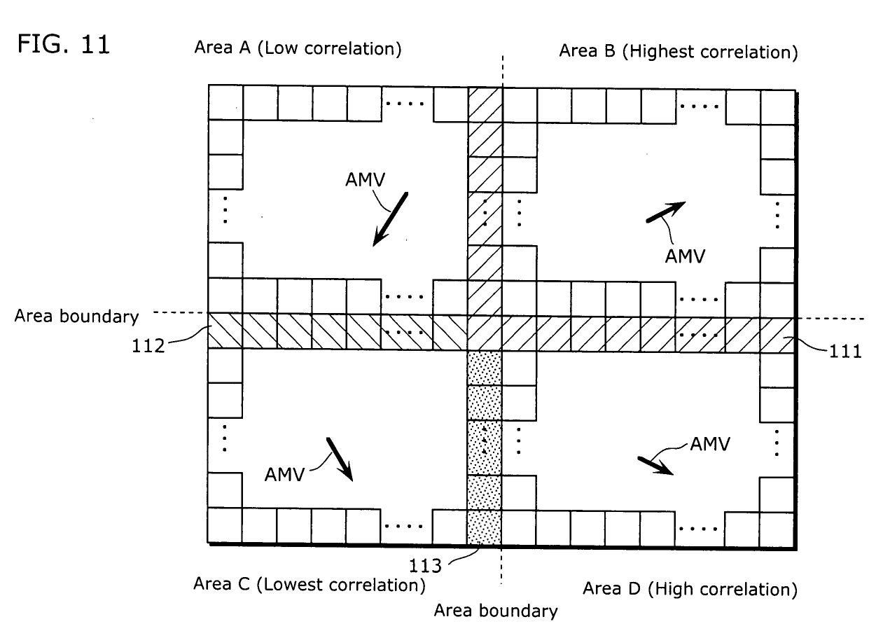

FIG. 11 is a diagram for illustrating how to correct the information about the motion vector search range in the motion vector estimating device according to the third embodiment. Since the motion vector estimating device is the same in structure as the motion vector estimating device in the first embodiment, a description of it is omitted.

The search range determining unit 6 corrects the information about the motion vector search range with respect to the macroblock which is positioned around the boundary between areas in accordance with the correlation between each set of adjacent areas. Here, as to the areas A to D of the picture to be coded, as shown in FIG. 11, the correlation values decrease in the order of areas B. D, A and C. In this case, the search range determining unit 6 corrects the information so that the area motion vector or the search range shift amount of a macroblock in an area which has a high correlation is used instead of using the area motion vector or the search range shift amount of a macroblock in an area which has a low correlation, and the macroblock is present in contact with the boundary between the search ranges with a high correlation and the search ranges with a low correlation. For example, as to an area 111 which is adjacent to the area B and included in the areas D, A and C, the information is corrected so that the area motion vector or the search range shift amount of the area B is used. In addition, as to an area 112 which is adjacent to the area A and included in the area C, the information is corrected so that the area motion vector 10 or the search range shift amount of the area A is used. In addition, as to an area 113 which is adjacent to the area D and included in the area C, the information is corrected so that the area motion vector or the search range shift amount of the area D is used.

As described above, the information about the motion vector search range with respect to each macroblock which is present in contact with the boundary between the areas is corrected in accordance with the correlation between each set of adjacent areas. Therefore, it is possible to determine the motion vector search ranges efficiently, and estimate motion vectors with a high accuracy.

It is assumed here that the macroblock sequence in contact with each boundary is a target. However, it is possible to determine plural macroblock sequences including the macroblock sequence in contact with each boundary as targets. In addition, the number of macroblocks to be corrected may be changed based on the correlation difference. Here are examples of cases where a correlation value is set between 0 and 1. When the correlation difference is 0.5 or above, the shift amount of the area motion vector or the search range is corrected by two macroblocks. When the correlation difference is not less than 0.25 and less than 0.5, the shift amount of the area motion vector or the search range is corrected by a macroblock. In addition, it is possible to replace the shift amount of the area motion vector or the search range of the macroblock around a boundary by performing linier compensation based on the correlation.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The motion vector estimating device and the motion vector estimating method according to the present invention is useful for an application of compressing a picture by performing inter-picture prediction, recording a TV broadcast program and taking a moving picture and the like. For example, they are applicable to personal computers, HDD recorders, DVD recorders, video cameras and mobile phones with a camera.

What is claimed is:

1. A motion vector estimating device which estimates a motion vector of a current block included in a picture to be coded with respect to a reference picture, said device comprising:
a picture reducing unit operable to generate, based on the picture to be coded and the reference picture, a reduced picture to be coded and a reduced reference picture each having a reduced number of pixels;
an area dividing unit operable to divide the reduced picture to be coded into a plurality of areas;
an area motion vector estimating unit operable to estimate an area motion vector which is a motion vector of each area obtained by the division performed by said area dividing unit, with respect to the reduced reference picture;
a search range determining unit operable to determine, based on the area motion vector, information about a motion vector search range of the current block included in the divided area; and
a motion estimating unit operable to estimate a motion vector of the current block by determining the motion vector search range of the current block based on the information about the motion vector search range determined by said search range determining unit and by searching the determined motion vector search range.

2. The motion vector estimating device according to claim 1,
wherein said search range determining unit is operable to determine, based on the area motion vector, a shift amount with respect to a standard position of the motion vector search range, the shift amount being determined as the information about the motion vector search range, and
said motion estimating unit is operable to determine the motion vector search range that is shifted from the standard position by the shift amount determined by said search range determining unit.

3. The motion vector estimating device according to claim 2,
wherein said search range determining unit is operable to determine the shift amount in proportion to a size of the area motion vector.

4. The motion vector estimating device according to claim 1, said device further comprising
a correlation calculating unit operable to calculate a correlation between the divided area picture and a divided area predictive picture which is generated based on the area motion vector and the reduced reference picture,
wherein said search range determining unit is operable to determine information about the motion vector search range based on the area motion vector and the correlation.

5. The motion vector estimating device according to claim 4,
wherein said search range determining unit is operable to determine, based on the area motion vector and the correlation, the shift amount with respect to the standard position of the motion vector search range, the shift amount being determined as the information about the motion vector search range, and
said motion estimating unit is operable to determine the motion vector search range that is shifted from the standard position by the shift amount determined by said search range determining unit.

6. The motion vector estimating device according to claim 5,
wherein said search range determining unit is operable to determine the shift amount in proportion to the size of the area motion vector and the correlation.

7. The motion vector estimating device according to claim 4,
wherein said search range determining unit is operable to determine a size of the motion vector search range based on the correlation as the information about the motion vector search range, and
said motion estimating unit is operable to determine the motion vector search range having the size of the motion vector search range determined by said search range determining unit.

8. The motion vector estimating device according to claim 7,
wherein said search range determining unit is operable to determine the size of the motion vector search range in an inverse proportion to the correlation.

9. The motion vector estimating device according to claim 4,
wherein said search range determining unit is operable to determine the size of the motion vector search range based on the area motion vector and the correlation, the size being determined as the information about the motion vector search range, and
said motion vector estimating unit is operable to determine the motion vector search range having the size of the motion vector search range determined by said search range determining unit.

10. The motion vector estimating device according to claim 9,
wherein said search range determining unit is operable to determine the size of the motion vector search range in proportion to the size of the area motion vector and in an inverse proportion to the correlation.

11. The motion vector estimating device according to claim 4,
wherein said search range determining unit is operable to determine, based on the correlation, an amount of search position decimation in searching a motion vector of the current block, the amount of search position decimation being determined as the information about the motion vector search range.

12. The motion vector estimating device according to claim 11,
wherein said search range determining unit is operable to determine the amount of search position decimation in an inverse proportion to the correlation.

13. The motion vector estimating device according to claim 11,
wherein said search range determining unit is operable to determine, as the amount of search position decimation, an amount of search position decimation within the motion vector search range.

14. The motion vector estimating device according to claim 11,
wherein said search range determining unit is operable to determine, as the amount of search position decimation, an amount of search position decimation in calculating an evaluation value of a motion vector in searching the motion vector.

15. The motion vector estimating device according to claim 4,
wherein said search range determining unit is operable to correct the information about the motion vector search range with respect to a block which is positioned around a boundary between the divided areas, according to the correlations of the respective divided areas adjacent to each other.

16. The motion vector estimating device according to claim 15,
wherein said search range determining unit is operable to compare the correlations of the respective adjacent divided areas and to correct information about the motion vector search range of a block in the divided area which has a lower correlation among the blocks around the boundary by using information about the motion vector search range of the divided area which has a higher correlation instead.

17. The motion vector estimating device according to claim 1,
wherein said search range determining unit is operable to determine, based on the area motion vector, the shift amount with respect to the standard position of the motion vector search range, the shift amount being determined as the information about the motion vector search range, and
said motion estimating unit is operable to determine, as the motion vector search range, a motion vector search range of the standard position and a range shifted from the standard position by the shift amount determined by said search range determining unit.

18. The motion vector estimating device according to claim 17,
wherein said motion estimating unit is further operable to determine, as the motion vector search range, a range shifted from the standard position using a predictive motion vector to be used in the current block.

19. A motion vector estimating method of estimating a motion vector of a current block included in a picture to be coded with respect to a reference picture, said method comprising:
generating, based on the picture to be coded and the reference picture, a reduced picture to be coded and a reduced reference picture each having a reduced number of pixels;
dividing the reduced picture to be coded into a plurality of areas;
estimating an area motion vector which is a motion vector of each area divided in said dividing, the motion vector being estimated with respect to the reduced reference picture;
determining, based on the area motion vector, information about a motion vector search range of the current block included in the divided area; and
estimating a motion vector of the current block by determining the motion vector search range of the current block based on the information about the motion vector search range determined in said determining and by searching the determined motion vector search range.

20. An integrated circuit for estimating a motion vector of a current block included in a picture to be coded with respect to a reference picture, the method which includes:
generating, based on the picture to be coded and the reference picture, a reduced picture to be coded and a reduced reference picture each having a reduced number of pixels;
dividing the reduced picture to be coded into a plurality of areas;
estimating an area motion vector which is a motion vector of each area divided in the dividing, the motion vector being estimated with respect to the reduced reference picture;
determining, based on the area motion vector, information about a motion vector search range of the current block included in the divided area; and
estimating a motion vector of the current block by determining the motion vector search range of the current block based on the information about the motion vector search range determined in the determining and by searching the determined motion vector search range.
